(19) United States
(12) Patent Application Publication
(10) Pub. No.: US 2004/0115508 A1
(43) Pub. Date: Jun. 17, 2004

(54) Stacked fuel cell, stacked fuel cell manufacturing method and manufacturing device thereof

(76) Inventor: Hironori Noto, Susono-shi (JP)

Correspondence Address: KENYON & KENYON, 1500 K STREET, N.W., SUITE 700, WASHINGTON, DC, 20005, US

(21) Appl. No.: 10/730,016

(22) Filed: Dec. 9, 2003

(30) Foreign Application Priority Data
Dec. 10, 2002 (JP) 2002-357831

(51) Int. Cl. H01M 8/24

(52) U.S. Cl. 429/34; 429/38

(57) ABSTRACT

A fuel cell of the invention includes a stacked cell unit having a plurality of stacked cells provided with separators; a stacked cell unit side surface of the stacked cell unit is surface smoothed. Further, a manufacturing method for the fuel cell includes a first step of stacking and fixing a plurality separators to form a fuel cell unit; and a second step of executing surface smoothing of a stacked cell unit side surface formed from a side surface of each of the separators of the fuel cell unit. In addition, a manufacturing device for the fuel cell fixes a plurality of cells having separators to form a fuel cell unit; and executes surface smoothing of a stacked cell unit side surface formed from a side surface of each of the separators of the fuel cell unit.

The disclosure of Japanese Patent Application No. 2002-357831 filed on Dec. 10, 2002 including the specification, drawings and abstract is incorporated herein by reference in its entirety.

### BACKGROUND OF THE INVENTION

1. Field of the Invention

The invention relates to a fuel cell (for example, a low temperature fuel cell such as a solid high polymer fuel cell), a manufacturing method for the fuel cell, and a manufacturing device for manufacturing the fuel cell.

2. Description of the Related Art

A solid high polymer fuel cell is configured from a layered unit including a membrane electrode assembly (hereinafter referred to as “MEA”) and separators. The MEA is configured from an electrolyte membrane formed from an ion exchange membrane; an electrode (an anode, fuel electrode) formed from a catalytic layer disposed on one surface of the electrolyte membrane; and an electrode (a cathode, air electrode) formed from a catalytic layer disposed on the other surface of the electrolyte membrane. Respective diffusion layers are provided on the anode side and the cathode side between the MEA and the separators. A fuel gas passage that supplies a fuel gas (hydrogen) to the anode, and an oxygen gas passage that supplies oxygen gas (oxygen, or normally, air) to the cathode are formed in the respective separators. Moreover, a coolant passage that feeds coolant (normally, cooling water) to the separators is also formed in the separators. A cell is configured by layering the MEA and the separators, and a module is configured from, at the least, one cell. Then, a stacked cell unit is configured by stacking modules. Finally, a stack is configured by positioning respective terminals, insulators and end plates at each end in a cell stacked direction of the stacked cell unit; tightening the stacked cell unit in the cell stacked direction; and fixing a tightening member (for example, a tension plate) that extends in the cell stacked direction from an external side of the stacked cell unit using bolts and nuts. A reaction in which hydrogen is broken down into hydrogen ions (protons) and electrons occurs at the anode side of each cell, and then the hydrogen ions move to the cathode side by passing through the electrolyte layer. Then, at the cathode side, the following reaction occurs in which water is generated from the oxygen and the hydrogen ions and electrons (electrons produced at the anode of the neighboring MEA move to the cathode side via the separator, or alternatively, electrons produced at the anode of the cell at one end in the cell stacked direction move to the cathode side of the cell at the other end via an external circuit.)

Anode side: H2→2H+2e⁻; Cathode side: 2H⁺+2e⁻ +(1/2)O₂→H₂O

In order for the above reaction to occur normally, the fuel gas (hydrogen), the oxygen gas (air) and the coolant (coolant water) are kept separate from each other so that they do not inter-mix. Moreover, adhesive is used to seal between the separators that face each other with the MEA sandwiched between them, and to seal between the catalytic layers and the separators. A gasket seals off the cells from each other, and the modules from each other. When internal fluid manifolds are formed in the separators, respective peripheries of fluid manifolds are also sealed with adhesive. Further, in a stack formed by stacking cells, the fluid manifolds, namely, a fuel gas manifold, an oxygen manifold, a coolant manifold, and the like, respectively pass through all the cells in the cell stacked direction (namely, the direction in which the cells are layered). The fluids that are supplied to the stack are fed into respective cell surfaces from an inflow side of the fluid manifolds, and then are fed through fluid passages within the cell surfaces and into an outflow side of the fluid manifolds so as to be fed out of the stack. In order for an electrical output of all the cells to become uniform, it is essential that respective amounts of reaction gases flowing into each cell are equal for all the cells. Japanese Patent Laid-Open Publication No. 2000-331691 discloses a configuration in which gas distribution to each cell is equalized by forming an angle of a gas feed side of a gas manifold of a separator that leads to a cell surface internal passage with a curved shape.

However, as a result of dimension errors of the separators caused during their manufacture, misalignment when assembling the cells and the modules in layers in the stack, and the like, a side surface of the stacked cell unit is uneven. (More specifically, this side surface is an end surface of the cell, and is at the end of the cell in a direction orthogonal to the cell surface and faces a space. This end surface may be a side surface of the stack, or an internal surface of the manifold within the stack). As a result, the amounts of the gasses that flow to the internal passages within the respective cell surfaces from the manifold vary from cell to cell. Accordingly, the battery output varies for each cell. The art disclosed in Japanese Patent Laid-Open Publication No. No. 2000-331691 is configured such that gas feed from the gas manifold to the passages within the cell surfaces occurs smoothly. However, due to the unevenness of the side surface of the stacked cell unit, the problem that the amount of gases flowing into the passages within the cell surfaces varies for each cell is not solved. It is an object of the invention to provide a stacked fuel cell, a manufacturing method for the stacked fuel cell, and a manufacturing device thereof, that inhibits and reduces the amount of gasses flowing into the passages within the respective cell surfaces from varying from cell to cell.

### SUMMARY OF THE INVENTION

In order to realize the above object, a fuel cell of the invention according to one aspect includes a stacked cell unit having a plurality of stacked cells provided with separators. This stacked cell unit has a stacked cell unit side surface that has been surface smoothed.

According to this aspect of the invention, protrusions and depressions of the stacked cell unit side surface are removed after the cells are stacked. Accordingly, it is possible to make the gas distribution to each cell equal, regardless of cell manufacturing or assembly error.

Moreover, the first aspect of the invention may further include an internal manifold formed so as to pass through the separators, and the stacked cell unit side surface may face the internal manifold. Further, the first aspect may be configured such that the stacked cell unit side surface is formed in a taper shape, and this taper shape may be formed such that a cross sectional area of the internal manifold becomes smaller in a fluid flow direction.

In addition, the first aspect of the invention may further include an adhesive that bonds the separators, and the adhesive may be surface smoothed at the same time as the surface smoothing of the stacked cell unit side surface. With this configuration, the adhesive that bonds the separators is surface smoothed along with the stacked cell unit side surface. Accordingly, even if sections of the adhesive protrude from the stacked cell unit side surface after the cells are stacked and prior to the surface smoothing process being executed, these sections of the adhesive are removed during the surface smoothing process. As a result, the stacked cell unit side surface is made even, and it is possible for gas distribution to each cell to be equalized, regardless of cell manufacturing or assembly errors.

Further, a fuel cell according to a second aspect of the invention includes a stacked cell unit having a plurality of stacked cells provided with separators; and an internal manifold formed so as to pass through the separators. This stacked cell unit has a stacked cell unit side surface which faces the internal manifold and which is smooth as compared to an other surface of the stacked cell unit.

According to the second aspect of the invention, protrusions and depressions of the stacked cell unit side surface are removed after the cells are stacked. Accordingly, it is possible to make the gas distribution to each cell equal, regardless of cell manufacturing or assembly error.

Moreover, according to the second aspect, the stacked cell includes a membrane electrode assembly, and the stacked cell unit side surface may be close to the membrane electrode assembly. Moreover, the other surface of the stacked cell unit may be an external surface that is parallel to a cell stacked direction of the stacked cell unit. Moreover, according to the second aspect, the stacked cell unit side surface may be formed in a taper shape, and this taper shape may be such that a cross sectional area of the internal manifold becomes smaller in a fluid flow direction. With this configuration, the stacked cell unit side surface that faces the fluid manifold is machined with the taper shape. By forming this taper shape during the process in which surface smoothing is executed, it is possible to address the problem of gas flow rate reducing toward the downstream side of the fluid manifold by simply executing the surface smoothing process. Thus, it is not necessary to repeat machining numerous times. Moreover, the second aspect may further include an adhesive that bonds the separators, and the adhesive may be surface smoothed at the same time as the surface smoothing of the stacked cell unit side surface.

In addition, a third aspect of the invention includes a stacked cell unit having a plurality of stacked cells provided with separators; an internal manifold formed so as to pass through the separators; and a sleeve that is inserted so as to form an internal surface of the internal manifold.

In the fuel cell according to the third aspect, the fluid manifold with the inserted sleeve is incorporated in the stack. Thus, the surface facing the fluid manifold becomes the internal surface of the sleeve that is smooth. This configuration realizes the same operation and effects in terms of surface smoothing as are achieved by removing the protrusions and depressions of the stacked cell unit side surface after stacking of the cells.

Moreover, a manufacturing method for the fuel cell according to a fourth aspect of the invention includes: a first step of stacking and fixing a plurality of cells having separators so as to form a stacked cell unit; and a second step of executing surface smoothing of a stacked cell unit side surface formed from a side surface of each of the separators of the stacked cell unit.

According to the fourth aspect of the invention, protrusions and depressions of a stacked cell unit side surface are removed after the cells are stacked. Accordingly, it is possible to make the gas distribution to each cell equal, regardless of cell manufacturing or assembly error.

In addition, the manufacturing method for the fuel cell according to the fourth aspect may be such that, in the second step, a machining tool is placed in contact with the stacked cell unit side surface; surface smoothing of the stacked cell unit side surface may then be executed by rotating or reciprocally moving this machining tool.

A manufacturing device for the fuel cell according to a fifth aspect of the invention stacks and fixes a plurality of cells having separators so as to form a stacked cell unit; and executes surface smoothing of a stacked cell unit side surface formed from a side surface of each of the separators of the stacked cell unit.

According to the fifth aspect of the invention, protrusions and depressions of a stacked cell unit side surface are removed after the cells are stacked. Accordingly, it is possible to make the gas distribution to each cell equal, regardless of cell manufacturing or assembly error.

### BRIEF DESCRIPTION OF THE DRAWINGS

FIG. 1 is a cross sectional view of a fluid manifold, and a portion of a stack in the vicinity thereof, of a stacked fuel cell according to the invention;

FIG. 2 is a cross sectional view prior to a surface smoothing process of a portion of a side surface of a stacked cell unit, and the portion of the stack in the vicinity thereof, of the stacked fuel cell according to the invention;

FIG. 3 is a cross sectional view following the surface smoothing process of the portion of the side surface of the stacked cell unit, and the portion of the stack in the vicinity thereof, of the stacked fuel cell according to the invention;

FIG. 4 is a cross sectional view of the stack portion in the case that a sleeve has been inserted in the fluid manifold of the stacked fuel cell according to the invention;

FIG. 5 is a cross sectional view of the stack portion in the case that the surface smoothing process and a tapering process have been carried out on the fluid manifold of the stacked fuel cell according to the invention;

FIG. 6 is a cross sectional view of a portion of the separators in the case that a burr and a notch are present at respective end portions of the separators (FIG. 6 illustrates a figurative representation prior to the surface smoothing process being carried out);

FIG. 7 is a cross sectional view of the portion of the separators in the case that surface smoothing process has been carried out on the respective end portions of the separators;

FIG. 8 is a graph showing a comparison of water distribution for the cases represented in FIGS. 6 and 7;

FIG. 9 is a side view of a stack of a normal stacked fuel cell; and

FIG. 10 is a cross sectional view of a portion of the stack of the normal fuel cell.

### DETAILED DESCRIPTION OF THE PREFERRED EMBODIMENTS

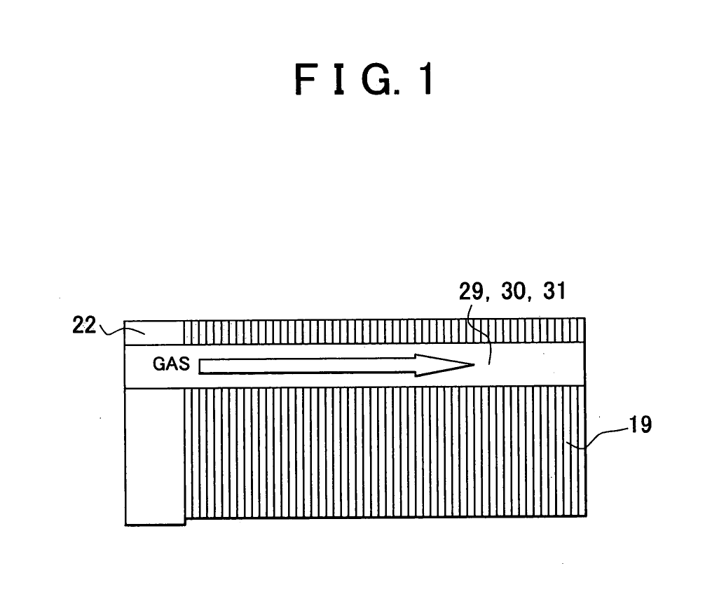

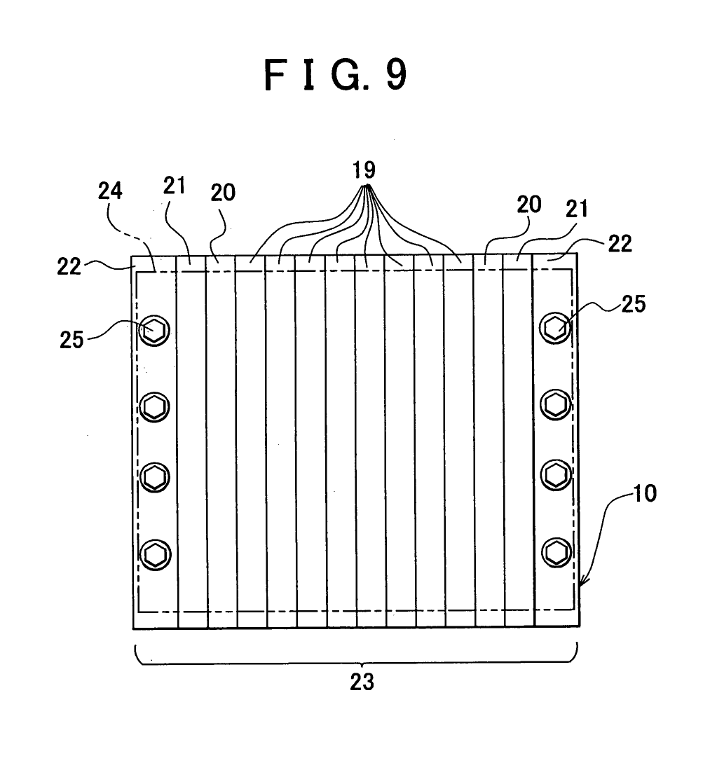

Hereinafter, a stacked fuel cell, a manufacturing method of the stacked fuel cell, and a manufacturing device thereof, will be explained with reference to FIGS. 1 to 10. The fuel cell according to the invention is intended for application to a low temperature fuel cell such as a solid high polymer fuel cell 10 (hereinafter referred to as “fuel cell 10”) shown in FIG. 9. The fuel cell 10 can be mounted, for example, in a fuel cell vehicle. However, the fuel cell 10 may be utilized for applications other than this.

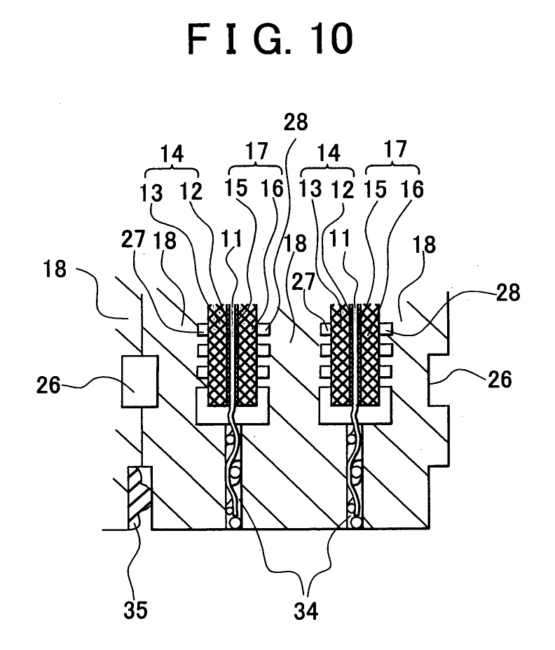

The fuel cell 10, as shown in FIGS. 9 and 10, is configured from a layered unit including a membrane electrode assembly (hereinafter referred to as “MEA”) and separators 18. The MEA is configured from an electrolyte membrane 11 formed from an ion exchange membrane; an electrode (an anode, fuel electrode) 14 formed from a catalytic layer 12 disposed on one surface of the electrolyte membrane 11; and an electrode (a cathode, air electrode) 17 formed from a catalytic layer 15 disposed on the other surface of the electrolyte membrane 11. Respective diffusion layers 13 and 16 are provided on the anode side and the cathode side between the MEA and the respective separators 18. A cell 19 is configured by layering the MEA and the separators 18, and a module is configured from, at the least, one of the cells 19. Then, a stacked cell unit is configured by stacking modules. Finally, a stack 23 is configured by positioning respective terminals 20, insulators 21, and end plates 22 at each end in a cell stacked direction (the thickness direction of the cells) of the stacked cell unit; tightening the stacked cell unit in the cell stacked direction; and fixing a tightening member (for example, a tension plate 24) that extends in the cell stacked direction from an external side of the stacked cell unit using bolts and nuts 25.

The separators 18 are formed from one of carbon, methanol, methanol and resin, or conductive resin, or alternatively, from a combination of these materials. In the example shown in the figures, the separators 18 are made from carbon. However, the separators 18 are not limited to those made from carbon. A fuel gas passage 27 that supplies a fuel gas (hydrogen) to the anode 14, and an oxygen gas passage 28 that supplies oxygen gas (oxygen, or normally, air) to the cathode 17 are formed in the respective separators 18. The fuel gas and the oxygen gas are both reactant gases. Further, a coolant passage 26 that feeds coolant (normally, cooling water) to the separators 18 is also formed in the separators 18. One of the coolant passage 26 is provided for each of a plurality of cells 19 (for example, one for each module). The fuel gas passage 27, the oxygen gas passage 28, and the coolant passage 26, respectively form internal fluid passages within the surface of the cell 19.

As shown in FIG. 1, a coolant manifold 29, a fuel gas manifold 30, and a oxygen gas manifold 31 are provided in the separators 18, which form a part of respective the cell 19, such that they pass through the separators 18 in the cell stacked direction. (It should be noted that, for ease of explanation, the three fluid manifolds 29, 30 and 31 are shown as one passage. However, in reality each fluid manifold 29, 30 and 31 is provided separately). The coolant manifold 29, the fuel gas manifold 30, and the oxygen gas manifold 31 form a fluid manifold formed within the stack 23. The fluid manifold is formed from an inflow side fluid manifold and an outflow side fluid manifold. The coolant is fed from the inflow side coolant manifold 29 to the outflow side coolant manifold 29 via the coolant passage 26 within the cell 19. The fuel gas is fed from the inflow side fuel gas manifold 30 to the outflow side fuel gas manifold 30 via the fuel gas passage 27 within the cell 19. The oxygen gas is fed from the inflow side oxygen gas manifold 31 to the outflow side oxygen gas manifold 31 via the oxygen gas passage 28 within the cell 19.

Moreover, as shown in FIG. 10, an adhesive 34 is used to seal the periphery of the electric generation area between the separators 18 that face each other with the electrolyte layer 11 sandwiched between them. A gasket 35 seals off the cells 19 from each other and the modules from each other. The adhesive 34 is in a liquid state when first applied, but when heated, or if left for a predetermined time period (for example, 24 hours), the adhesive 34 becomes hard.

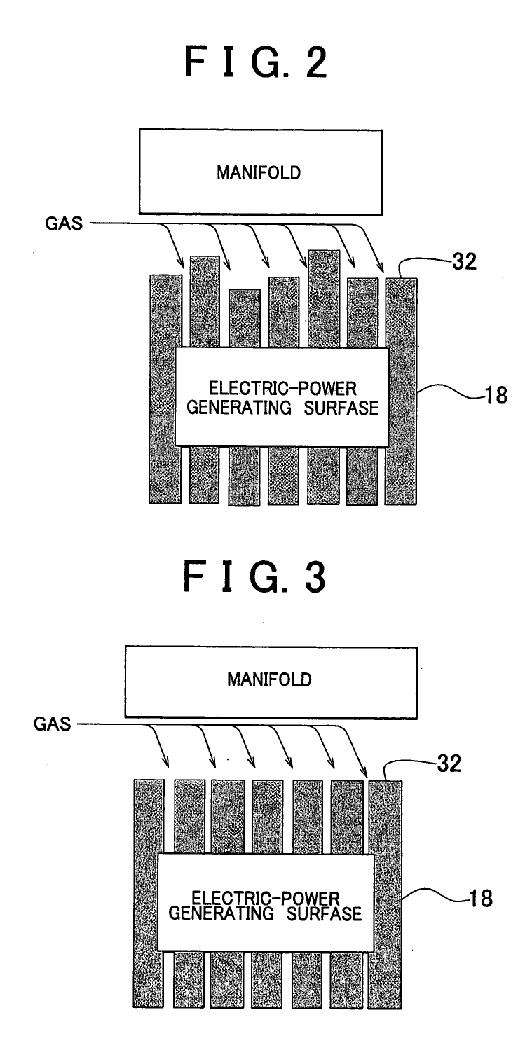

The fuel cell 10 is made by stacking a plurality of the cells 19 provided with the separators 18. As shown in FIG. 3, following stacking of the cells 19, the fuel cell 10 has a stacked cell unit side surface 32 (which corresponds to a side surface at an end portion of the cells 19 in a direction orthogonal to the cell stacked direction; this side surface faces a space). In the case of the internal fluid manifold, namely, when the fluid manifold 29, 30 and 31 is provided within the stack 23, this stacked cell unit side surface may be an internal surface (corresponding to a stacked cell unit side surface that faces the internal fluid manifold) of the internal fluid manifold of the stack 23. Moreover, in the case that a fluid manifold is provided as an external manifold outside of the stack 23, the stacked cell unit side surface may be an external side surface of the stack 23. As shown in FIG. 2, following stacking of the cells 19, without execution of surface smoothing, the stacked cell unit side surface 32 is normally uneven and has protrusions and depressions. However, according to the invention, surface smoothing is executed following the layering of the cells 19. Thus, the stacked cell unit side surface 32 becomes an even smoothed surface. In the case of the internal fluid manifold, the stacked cell unit side surface 32, on which the surface smoothing process is executed, is the internal surface of the inflow sides of the fluid manifolds 29, 30 and 31. Note that, in this case, the surface smoothing process may be executed on the internal surface of the outflow sides of the fluid manifolds 29, 30 and 31 as well.

In the case that the stacked cell unit side surface 32 that is surface smoothed is the internal surface of the fluid manifold 29, 30 and 31, the surface of the stacked separators 18, which faces the internal surface of the fluid manifold 29, 30 and 31 and which has been smoothed, is a more even surface than the external surface of the stacked separators 18 of the stacked cell unit that has not been smoothed.

When the separators 18 are in a fixed stacked state, the adhesive 34 that bond the separators 18 is provided between the separators 18. When the surface smoothing process is being executed on the stacked cell unit side surface 32, any sections of the adhesive 34 that protrude from the separators 18 are also surface smoothed at the same time as the surface smoothing process is executed for the stacked cell unit side surface 32. Accordingly, unevenness resulting from the adhesive 34 is also removed.

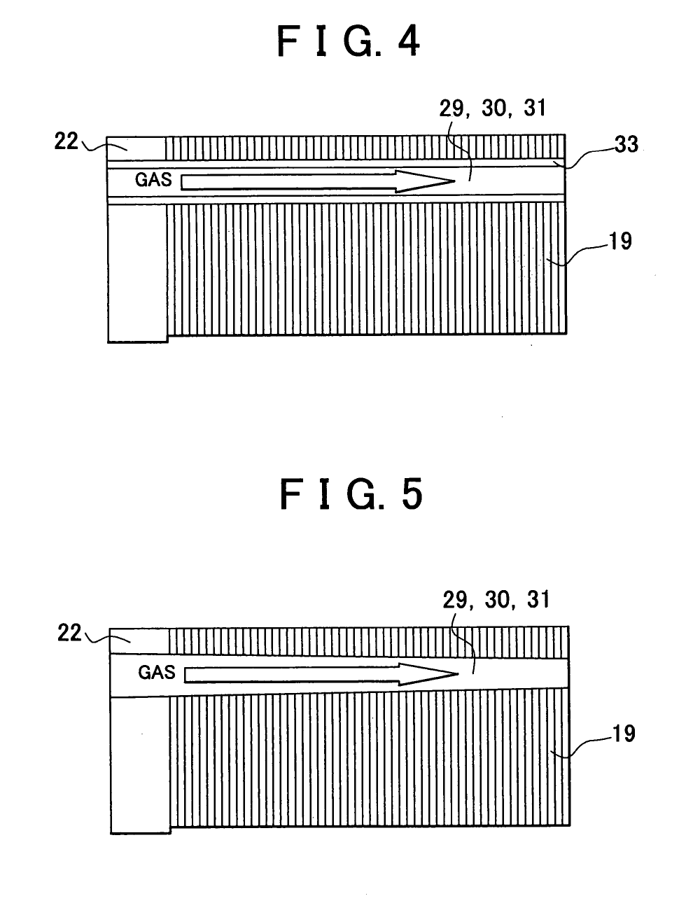

In the embodiment of the invention shown in FIG. 4, the fuel cell 10 made from the plurality of the stacked cells 19 with the separators 18 has a sleeve 33 inserted into the fluid manifold 29, 30 and 31. By incorporating the fluid manifold 29, 30 and 31 with the inserted sleeve 33 in the stack 32, the surface facing the fluid manifold 29, 30 and 31 becomes an internal surface of the sleeve 33 that is smooth. Note that the sleeve 33 is provided with perforated holes such that fluid can pass through freely. Moreover, the sleeve 33 is made from a material, for example, resin, that has electric insulating properties so that the respective pairs of the separators 11 with the MEA sandwiched between them are not electrically continuous.

In the embodiment shown in FIG. 5, the stacked cell unit side surface 32 which faces the fluid manifold 29, 30 and 31 and which is to be surface smoothed is machined so as to have a taper shape that tapers toward an downstream side of the inflow side of the intake fluid manifold 29, 30 and 31 (which corresponds to an inward side of a stack layer direction when viewed from a fluid flow direction) such that a cross sectional area of the fluid manifold 29, 30 and 31 passage becomes smaller. The taper processing of this internal surface of the fluid manifold 29, 30 and 31 is executed at the same time as the surface smoothing process.

A manufacturing method for the fuel cell 10 in which the stacked cell unit side surface 32 is surface smoothed includes the following steps: in step one, two or more of the cells 19 including the separators 18 are stacked and fixed so to form a stacked cell unit; following this, in step two, the surface smoothing process is executed on the surface formed by the stacked cell unit side surfaces 32 of each of the stacked separators 18 of the stacked cell unit. The surface smoothing process is executed, for example, by stacking a plurality of the cells 19 (for example 100 layers); inserting a machining tool in the fluid manifold 29, 30 and 31; and machining the internal surface of the separators 18 by rotating the machining tool whilst supporting it from both ends, or alternatively, moving the machining tool reciprocally.

Moreover, a manufacturing device for the fuel cell 10 in which the stacked cell unit side surface 32 is surface smoothed includes a first unit that stacks and fixes two or more of the cells 19 including the separators 18 so as to form a stacked cell unit; and a second unit that surface smoothes the surface formed by the stacked cell unit side surfaces 32 of each of the stacked separators 18 of the stacked cell unit. This manufacturing device may be assembled to a stack assembly jig. Alternatively, the manufacturing device may be assembled to a separate stack assembly jig, and the stack 23 may be moved on its stack assembly jig to the manufacturing device that executes the surface smoothing process.

Next, an operation of the stacked fuel cell 10 of the invention, execution of the manufacturing method, and the manufacturing device thereof will be explained. With the stacked fuel cell 10, the manufacturing method and the manufacturing device thereof, the protrusions and depressions of the stacked cell unit side surface 32 are removed after the cells 19 have been stacked. Accordingly, it is possible to make the gas distribution to each cell 19 equal, regardless of cell manufacturing or assembly error.

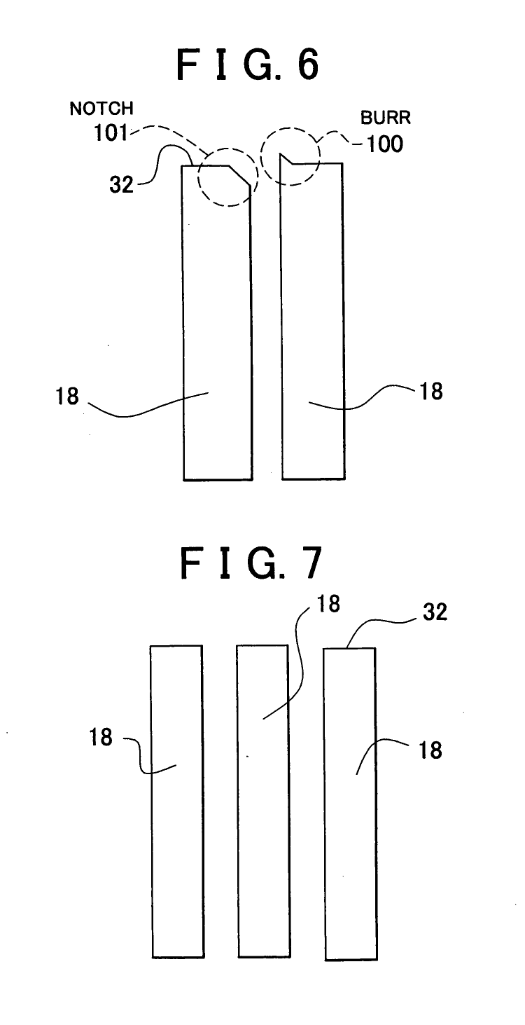

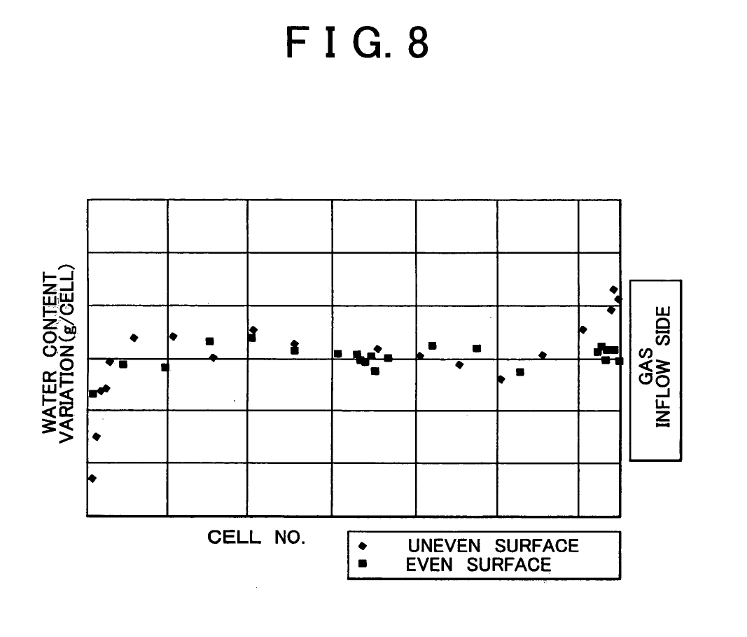

An investigation was conducted concerning the difference in electricity generation performance when the fuel cell is operated, in the case that the cells 19 of the fuel cell 10 have a burr 100 and a notch 101, as shown in FIG. 6, and in the case that the internal surfaces of the fluid manifold 29, 30 and 31 are surface smoothed following assembly of the stack 23. The difference in gas flow rate is influenced by the water content with the cells 19. Accordingly, the respective water contents of the cells 19 in the states of FIGS. 6 and 7 were estimated. The results are shown in FIG. 8; as can be seen, it was confirmed that the water content within the cells 19 of the fuel cell 10 according to the invention is equal. More specifically, in the case that there are protrusions and depressions, the water content is large, and the gas amount is small. However, in the case that there are no protrusions and depressions (when surface smoothing has been executed), the water distribution is even. As a result, the distribution of the gas amount is equal. Accordingly, it is apparent that surface smoothing of the internal surface of the fluid manifold 29, 30 and 31 results in a reduction in disturbance of the gas, and an improvement of distribution performance. The above described operation and effects can also be realized in the case of the external manifold.

The adhesive 34 that bonds the separators 18 is surface smoothed along with the stacked cell unit side surface 32. Accordingly, even if sections of the adhesive 34 protrude from the stacked cell unit side surface 32 after the cells are stacked and prior to the surface smoothing process being executed, these sections of the adhesive 34 are removed during the surface smoothing process. As a result, the stacked cell unit side surface 32 is made even, and it is possible for gas distribution to each cell 19 to be equalized, regardless of cell manufacturing or assembly errors.

With the stacked fuel cell 10 shown in FIG. 4, the sleeve 33 is inserted into the fluid manifold 29, 30 and 31. By incorporating the fluid manifold 29, 30 and 31 with the inserted sleeve 33 in the stack 32, the surface facing the fluid manifold 29, 30 and 31 becomes the internal surface of the sleeve 33 that is smooth. This configuration realizes the same operation and effects in terms of surface smoothing and equalizing the gas distribution to each cell 19 as are achieved by removing the protrusions and depressions of the stacked cell unit side surface 32 after stacking of the cells 19.

With the stacked fuel cell 10 shown in FIG. 5, the stacked cell unit side surface 32 facing the fluid manifold 29, 30 and 31 is machined with the taper shape. By forming this taper shape during the process in which surface smoothing is executed, it is possible to address the problem of gas flow rate reducing further downstream within the fluid manifold 29, 30 and 31 by simply executing the surface smoothing process. Thus, it is not necessary to repeat machining numerous times.

What is claimed is:

1. A fuel cell comprising:
a stacked cell unit including a plurality of stacked cells having separators; wherein
the stacked cell unit has a stacked cell unit side surface that is surface smoothed.

2. The fuel cell according to claim 1, further comprising:
an internal manifold that is formed so as to pass through the separators, and wherein
the stacked cell unit side surface faces the internal manifold.

3. The fuel cell according to claim 1, wherein
the stacked cell unit side surface is formed in a taper shape.

4. The fuel cell according to claim 3, wherein
the stacked cell unit side surface is formed in the taper shape such that a cross sectional area of the internal manifold becomes smaller in a fluid flow direction.

5. The fuel cell according to claim 1, further comprising:
an adhesive that bonds the separators; and wherein
the adhesive is surface smoothed at the same time as the surface smoothing of the stacked cell unit side surface.

6. A fuel cell comprising:
a stacked cell unit including a plurality of stacked cells having separators;
an internal manifold formed so as to pass through the separators, wherein
the stacked cell unit has a stacked cell unit side surface which faces the internal manifold and which is smooth as compared to an other surface of the stacked cell unit.

7. The fuel cell according to claim 6, wherein
the stacked cell includes a membrane electrode assembly, and the stacked cell unit side surface is close to the membrane electrode assembly.

8. The fuel cell according to claim 6, wherein
the other surface of the stacked cell unit is an external surface that is parallel to a cell stacked direction of the stacked cell unit.

9. The fuel cell according to claim 6, wherein
the stacked cell unit side surface is formed in a taper shape.

10. The fuel cell according to claim 9, wherein
the stacked cell unit side surface is formed in the taper shape such that a cross sectional area of the internal manifold becomes smaller in a fluid flow direction.

11. The fuel cell according to claim 6, further comprising:
an adhesive that bonds the separators; and wherein
the adhesive is surface smoothed at the same time as the surface smoothing of the stacked cell unit side surface.

12. A fuel cell comprising:
a stacked cell unit including a plurality of stacked cells having separators;
an internal manifold formed so as to pass through the separators; and
a sleeve that is inserted within the internal manifold.

13. The fuel cell according to claim 12, wherein
the sleeve is inserted so as to form an internal surface of the internal manifold.

14. A manufacturing method for the fuel cell, comprising:
a first step of stacking and fixing a plurality of cells having separators so as to form a stacked cell unit; and
a second step of executing surface smoothing of a stacked cell unit side surface formed from a side surface of each of the separators of the stacked cell unit.

15. The manufacturing method for the fuel cell according to claim 14, wherein
in the second step, a machining tool is placed in contact with the stacked cell unit side surface, and this machining tool is at least one of rotated and reciprocally moved in order to execute the surface smoothing of the stacked cell unit side surface.

16. A manufacturing device for the fuel cell, comprising:
a fixing portion that stacks and fixes a plurality of cells having separators so as to form a stacked cell unit; and
a machining portion that executes surface smoothing of a stacked cell unit side surface formed from a side surface of each of the separators of the stacked cell unit.

17. The manufacturing device for the fuel cell according to claim 16, wherein
the machining portion places a machining tool in contact with the stacked cell unit side surface, and then at least one of rotates and reciprocally moves this machining tool in order to execute the surface smoothing.
